(19) United States
(12) Patent Application Publication
(10) Pub. No.: US 2025/0086807 A1
(43) Pub. Date: Mar. 13, 2025

(54) APPARATUS FOR CONTROLLING VEHICLE AND METHOD THEREOF

(71) Applicants: Hyundai Motor Company, Seoul (KR); Kia Corporation, Seoul (KR)

(72) Inventors: Ju Hyeok Ra, Guri-si (KR); Yoon Suk Jang, Seoul (KR)

(21) Appl. No.: 18/629,421

(22) Filed: Apr. 8, 2024

(30) Foreign Application Priority Data
Sep. 11, 2023 (KR) 10-2023-0120571

(51) Int. Cl. G06T 7/187; G06T 7/11; G06T 7/246; G06T 7/60; G06T 7/73; G06V 20/58

(52) U.S. Cl. CPC G06T 7/187; G06T 7/11; G06T 7/246; G06T 7/60; G06T 7/73; G06V 20/58; G06T 2207/30196; G06T 2207/30252

(57) ABSTRACT

The present disclosure may relate to a vehicle control apparatus and a method thereof. A vehicle control apparatus may include a sensor and a processor. The processor may convert a first virtual box, associated with a first object and obtained via the sensor at a first time, into a second virtual box associated with a second time that, determine a plurality of third virtual boxes, associated with the second virtual box, based on a plurality of data points obtained at the second time via the sensor, merge at least part of the plurality of third virtual boxes into a merge box, maintain or cancel the merging of the at least part of the plurality of third virtual boxes, and output a signal indicating a result of the maintaining or canceling of the merging.

### CROSS-REFERENCE TO RELATED APPLICATION

This application claims the benefit of priority to Korean Patent Application No. 10-2023-0120571, filed in the Korean Intellectual Property Office on Sep. 11, 2023, the entire contents of which are incorporated herein by reference.

### TECHNICAL FIELD

The present disclosure relates to a vehicle control apparatus and a method thereof, and more particularly, relates to a technology for using light detection and ranging (LiDAR).

### BACKGROUND

Various studies are being conducted to identify an external object with respect to a host vehicle by using various sensors to assist the host vehicle in driving.

In particular, while the host vehicle is driving in a driving assistance device activation mode or an autonomous driving mode, the external object may be identified by using a LiDAR.

In a process of merging virtual boxes generated by using the LiDAR, two or more virtual boxes may be incorrectly merged. When a merge box, which is obtained by incorrectly merging the virtual boxes, is mapped to an external object, the type, state, or size of the external object may be incorrectly identified. When the type, state, or size of an external object is incorrectly identified, a driving route of a host vehicle may change unexpectedly and unnecessarily.

### SUMMARY

The present disclosure has been made to solve the above-mentioned problems occurring in at least some implementations while advantages achieved by those implementations are maintained intact.

An aspect of the present disclosure provides a vehicle control apparatus that merges virtual boxes generated by using a sensor (e.g., LiDAR) or unmerges the merge box, and a method thereof.

An aspect of the present disclosure provides a vehicle control apparatus that reduces a load of a processor by determining whether to merge virtual boxes before merging the virtual boxes, and a method thereof.

An aspect of the present disclosure provides a vehicle control apparatus that accurately identifies a pedestrian when it is identified that the pedestrian is separated from a road boundary (e.g., a guardrail, a median, a curb, etc.), and a method thereof.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a vehicle control apparatus may include: a sensor and a processor. The processor may be configured to: convert a first virtual box, associated with a first object and obtained via the sensor at a first time, into a second virtual box associated with a second time that is later than the first time; determine a plurality of third virtual boxes, associated with the second virtual box, based on a plurality of data points obtained at the second time via the sensor; merge at least part of the plurality of third virtual boxes into a merge box based on at least one of: a distance between two or more of the plurality of third virtual boxes at the second time, or whether at least one of the plurality of third virtual boxes at the second time corresponds to a second object that is separated from a road boundary; maintain or cancel the merging of the at least part of the plurality of third virtual boxes based on at least one of: a distance between two or more data points included in the merge box, or a type of the first object; and output a signal indicating a result of the maintaining or canceling of the merging.

The processor may be configured to determine the plurality of third virtual boxes by determining the plurality of third virtual boxes based on at least one of: the second virtual box overlapping each of the plurality of third virtual boxes at the second time by a proportion greater than a first threshold value, or a distance between a plurality of first data points included in the second virtual box and a plurality of second data points included in the plurality of third virtual boxes at the second time being within a second threshold value.

The processor may be further configured to: determine whether the first object is stationary or moving based on at least one of: the first object being not occluded, the type of the first object being a pedestrian, or a number of the plurality of third virtual boxes at the second time being less than a threshold value.

The at least part of the plurality of third virtual boxes may include a fourth virtual box and a fifth virtual box. The processor may be configured to maintain or cancel the merging by canceling the merging based on: the first object being stationary, at least one of a width or a length of the second virtual box being greater than or equal to a first threshold value, and a distance between a first straight line, which is perpendicular to a line segment forming the fourth virtual box and passes a center of the fourth virtual box at the second time, and a center of the fifth virtual box at the second time being greater than or equal to a second threshold value.

The at least part of the plurality of third virtual boxes may include a fourth virtual box and a fifth virtual box. The processor may be configured to maintain or cancel the merging by canceling the merging based on: the first object being moving, a width and a length of each of the plurality of third virtual boxes at the second time being less than or equal to a first threshold value, and a distance between a center of the fourth virtual box and a center of the fifth virtual box being greater than or equal to a second threshold value that is greater than the first threshold value.

The processor may be further configured to determine, among the plurality of third virtual boxes at the second time, a fourth virtual box that is closest to a vehicle associated with the vehicle control apparatus. A width and a length of the fourth virtual box may be greater than or equal to a threshold value. The processor may be further configured to determine, among the plurality of third virtual boxes at the second time, a fifth virtual box associated with the second object; and cancel merging of the fourth virtual box and the fifth virtual box.

The processor may be further configured to: determine a fourth virtual box and a fifth virtual box that are, among the plurality of third virtual boxes at the second time, furthest away from each other based on: the first object being not occluded, the type of the first object not being a specialty vehicle, and one of a width or a length of the merge box being greater than or equal to a first threshold value.

The processor may be further configured to: cancel merging of the fourth virtual box and the fifth virtual box based on a distance between a first data point, in the fourth virtual box, closest to the fifth virtual box and a second data point, in the fifth virtual box, closest to the fourth virtual box being greater than a second threshold value that is less than the first threshold value.

The processor may be further configured to determine an object type associated with the merge box based on: the first object being moving, a width of the merge box being less than or equal to a first threshold value, a length of the merge box being less than or equal to a second threshold value that is greater than the first threshold value, and the merge box being associated with an area that is at least a threshold distance away from a boundary of a field of view of the sensor.

The processor may be configured to maintain or cancel the merging by canceling the merging based on: the type of the first object being a pedestrian, and one of the width of the merge box or the length of the merge box being greater than or equal to a third threshold value threshold value that is less than the first threshold value.

According to one or more example embodiments of the present disclosure, a vehicle control method may include: converting, by one or more processors of a vehicle, a first virtual box, associated with a first object and obtained via a sensor at a first time, into a second virtual box associated with a second time that is later than the first time; determining a plurality of third virtual boxes, associated with the second virtual box, based on a plurality of data points obtained at the second time via the sensor; merging at least part of the plurality of third virtual boxes into a merge box based on at least one of: a distance between two or more of the plurality of third virtual boxes at the second time, or whether at least one of the plurality of third virtual boxes at the second time corresponds to a second object that is separated from a road boundary; and maintaining or canceling the merging of the at least part of the plurality of third virtual boxes based on at least one of: a distance between two or more data points included in the merge box, or a type of the first object; and outputting a signal indicating a result of the maintaining or canceling of the merging.

Determining the plurality of third virtual boxes may include determining the plurality of third virtual boxes based on at least one of: the second virtual box overlapping each of the plurality of third virtual boxes at the second time by a proportion greater than a first threshold value, or a distance between a plurality of first data points included in the second virtual box and a plurality of second data points included in the plurality of third virtual boxes at the second time being within a second threshold value.

The method may further include: determining whether the first object is stationary or moving based on at least one of:

the first object being not occluded, the type of the first object being a pedestrian, or a number of the plurality of third virtual boxes at the second time being less than a threshold value.

The at least part of the plurality of third virtual boxes may include a fourth virtual box and a fifth virtual box. Maintaining or canceling the merging may include cancelling the merging based on: the first object being stationary, at least one of a width or a length of the second virtual box being greater than or equal to a first threshold value, and a distance between a first straight line, which is perpendicular to a line segment forming the fourth virtual box and passes a center of the fourth virtual box at the second time, and a center of the fifth virtual box at the second time being greater than or equal to a second threshold value.

The at least part of the plurality of third virtual boxes may include a fourth virtual box and a fifth virtual box. Maintaining or canceling the merging may include canceling the merging based on: the first object being moving, a width and a length of the plurality of third virtual boxes at the second time being less than or equal to a first threshold value, and a distance between a center of the fourth virtual box and a center of the fifth virtual box being greater than or equal to a second threshold value greater than the first threshold value.

The method may further include determining, among a plurality of third virtual boxes at the second time, a fourth virtual box that is closest to the vehicle. A width and a length of the fourth virtual box may be greater than or equal to a threshold value. The method may further include determining, among the plurality of third virtual boxes at the second time, a fifth virtual box associated with the second object; and canceling merging of the fourth virtual box and the fifth virtual box.

The method may further include: determining a fourth virtual box and a fifth virtual box that are, among the plurality of third virtual boxes at the second time, furthest away from each other based on: the first object being not occluded, the type of the first object not being a specialty vehicle, and one of a width or a length of the merge box being greater than or equal to a first threshold value.

The method may further include: canceling merging of the fourth virtual box and the fifth virtual box based on a distance between a first data point, in the fourth virtual box, closest to the fifth virtual box and a second data point, in the fifth virtual box, closest to the fourth virtual box being greater than a second threshold value that is less than the first threshold value.

The method may further include determining an object type associated with the merge box based on: the first object being moving, a width of the merge box being less than or equal to a first threshold value, a length of the merge box being less than or equal to a second threshold value that is greater than the first threshold value, and the merge box being associated with an area that is at least a threshold distance away from a boundary of a field of view of the sensor.

Maintaining or canceling the merging may include canceling the merging based on: the type of the first object being a pedestrian, and one of the width of the merge box or the length of the merge box being greater than or equal to a third threshold value threshold value that is less than the first threshold value.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a block diagram of a vehicle control apparatus, according to an embodiment of the present disclosure;

FIG. 2 shows an example of generating a merge box by using virtual boxes, in an embodiment of the present disclosure;

FIG. 3 shows an example of identifying a distance between virtual boxes;

FIG. 4 shows an example in which an object separated from a road edge and virtual boxes at a second time point are not merged;

FIG. 5 shows an example of separating a merge box based on a plurality of points included in virtual boxes;

FIG. 6 shows an example of a result of separating a merge box.

FIG. 7 shows an example of a flowchart of a vehicle control method; and

FIG. 8 shows a computing system associated with a vehicle control apparatus.

### DETAILED DESCRIPTION

Hereinafter, one or more example embodiments of the present disclosure will be described in detail with reference to the accompanying drawings. In adding reference numerals to components of each drawing, it should be noted that the same components have the same reference numerals, although they are indicated on another drawing. Furthermore, in describing the one or more example embodiments of the present disclosure, detailed descriptions associated with well-known functions or configurations will be omitted when they may make subject matters of the present disclosure unnecessarily obscure.

In describing elements of example embodiments of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as having a meaning that is consistent with their meaning in the context of the present disclosure and the relevant art and will not be interpreted in an idealized or overly formal unless expressly so defined herein.

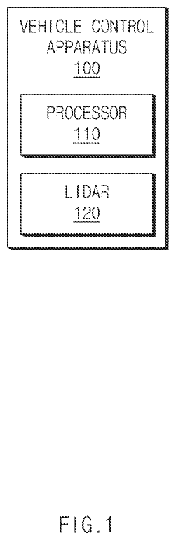

Hereinafter, one or more example embodiments of the present disclosure will be described in detail with reference to FIGS. 1 to 8.

FIG. 1 shows an example of a block diagram of a vehicle control apparatus.

Referring to FIG. 1, a vehicle control apparatus 100 may be implemented inside or outside a vehicle, and some of components included in the vehicle control apparatus 100 may be implemented inside or outside the vehicle. At this time, the vehicle control apparatus 100 may be integrated with internal control units of a vehicle and may be implemented with a separate device so as to be connected to control units of the vehicle by means of a separate connection means. For example, the vehicle control apparatus 100 may further include components not shown in FIG. 1.

Referring to FIG. 1, the vehicle control apparatus 100 may include a processor 110 and a LiDAR 120. The processor 110 or the LiDAR 120 may be electrically or operably connected to each other by an electronic component including a communication bus.

Hereinafter, the fact that pieces of hardware are coupled operably may include the fact that a direct or indirect connection between the pieces of hardware is established wired or wirelessly such that second hardware is controlled by first hardware among the pieces of hardware. Although different blocks are shown, the disclosure is not limited thereto.

Some of the pieces of hardware in FIG. 1 may be included in a single integrated circuit including a system on a chip (SoC). The type or number of hardware included in the vehicle control apparatus 100 is not limited to that shown in FIG. 1. For example, the vehicle control apparatus 100 may include only some of the pieces of hardware shown in FIG. 1.

The vehicle control apparatus 100 may include hardware for processing data based on one or more instructions. The hardware for processing data may include the processor 110.

For example, the hardware for processing data may include an arithmetic and logic unit (ALU), a floating point unit (FPU), a field programmable gate array (FPGA), a central processing unit (CPU), and/or an application processor (AP). The processor 110 may have the structure of a single-core processor, or may have a structure of a multi-core processor including a dual-core, a quad-core, a hexa-core, or an octa-core.

The LiDAR 120 included in the vehicle control apparatus 100 may obtain data sets from identifying objects surrounding the vehicle control apparatus 100. For example, the LiDAR 120 may identify at least one of a location of the surrounding object, a movement direction of the surrounding object, a speed of the surrounding object, or any combination thereof based on a pulse laser signal that is emitted from the LiDAR 120, reflected by the surrounding object, and returned.

The processor 110 included in the vehicle control apparatus 100 may obtain a virtual box at a first time point corresponding to an object, which is specified at the first time point, through the LiDAR 120. For example, the processor 110 may obtain a virtual box at the first time point by using a plurality of points, which are obtained at the first time point, through the LiDAR 120.

The processor 110 may generate a tracking box, which is obtained by converting the virtual box at the first time point into a virtual box at the second time point after the first time point.

For example, at least one of the first time point, the second time point, or any combination thereof may include a time point for obtaining a data set through the LiDAR 120. For example, the second time point may be referred to as a current time point (e.g., time point ‘t’). For example, the second time point may include a time point at which a current frame is obtained. For example, the first time point may include a time point immediately before the current frame is obtained. For example, the first time point may include time point ‘t−1’. It is expressed that a time point is at least one of the first time point, second time point, or any combination thereof. However, at least one of the first time point, second time point, or any combination thereof may mean a frame number. For example, when the second time point means a t-th frame, the first time point may mean a (t−1)-th frame.

The processor 110 may obtain a plurality of points at a second time point through the LiDAR 120. For example, the processor 110 may obtain virtual boxes at the second time point, which are formed by a plurality of points obtained at the second time point, through the LiDAR 120. For example, the virtual boxes at the second time point may be referred to as a “meta box”. For example, the virtual boxes at the second time point may include boxes formed based on points obtained as light emitted from the LIDAR 120 is reflected from an external object.

The processor 110 may identify virtual boxes associated with a tracking box among the virtual boxes at the second time point based on obtaining virtual boxes at the second time point.

For example, the processor 110 may identify a ratio (e.g., proportion) at which the tracking box overlaps each of the virtual boxes obtained at the second time point. For example, the processor 110 may identify that the tracking box overlaps each of the virtual boxes obtained at the second time point at a specified ratio (e.g., about 25%) or more.

For example, the processor 110 may identify a distance between a plurality of first points included in the tracking box and a plurality of second points included in the virtual boxes at the second time point. For example, the processor 110 may determine whether a distance between the plurality of first points included in the tracking box and the plurality of second points included in the virtual boxes at the second time point is within a correlation distance. For example, the correlation distance may be referred to as “Mahalanobis distance”.

The processor 110 may identify virtual boxes associated with the tracking box among the virtual boxes at the second time point based on the fact that the tracking box overlaps each of the virtual boxes obtained at the second time point by a specified ratio (e.g., proportion) or more, or the distance between the plurality of first points included in the tracking box and the plurality of second points included in the virtual boxes at the second time point is identified as being within the correlation distance.

For example, the processor 110 may identify virtual boxes associated with the tracking box by identifying that the tracking box overlaps each of the virtual boxes obtained at the second time point by a specified ratio (e.g., proportion) or more, or the distance between the plurality of first points included in the tracking box and the plurality of second points included in the virtual boxes at the second time point is within the correlation distance.

The processor 110 may merge all or part of the associated virtual boxes based on at least one of a distance between the virtual boxes at the second time point, whether at least one of the virtual boxes at the second time point corresponds to an object separated from a road boundary (e.g., edge), or any combination thereof.

For example, when the distance between virtual boxes at the second time point is long, the processor 110 may not merge virtual boxes at the second time point. An operation of not merging virtual boxes at the second time point will be described later.

The processor 110 may determine whether to merge virtual boxes at the second time point, based on at least one of whether a specified object is occluded, the type of the specified object, the number of virtual boxes at the second time point, or any combination thereof.

For example, the processor 110 may determine whether the specified object is in a moving state, based on the fact that the specified object is not occluded, the type of the specified object is identified as being of a first specified type including a pedestrian, and the number of virtual boxes at the second time point is smaller than the specified number (e.g., 3). For example, the processor 110 may identify the stationary or moving state of the specified object based on the fact that the specified object is not occluded, the type of the specified object is identified as being of the first specified type including a pedestrian, and the number of virtual boxes at the second time point is smaller than the specified number.

The processor 110 may identify that the specified object is in the stationary state. When the specified object is in the stationary state, the processor 110 may perform the following operations.

For example, the processor 110 may identify a width or length of the tracking box. The processor 110 may identify that at least one of the width or length of the tracking box is greater than or equal to a first reference length (e.g., about 30 m).

The processor 110 may identify a first straight line perpendicular to a line segment forming a first virtual box from a first center point of the first virtual box among the virtual boxes at the second time point, based on the fact that the specified object is in the stationary state and at least one of the width or length of the tracking box is greater than or equal to the first reference length.

For example, the processor 110 may identify the first straight line perpendicular to the line segment forming the first virtual box from the first center point of the first virtual box among the virtual boxes at the second time point, by projecting a plurality of points obtained through the LiDAR 120 onto a plane formed by an x-axis and a y-axis among the x-axis, the y-axis, and a z-axis.

The processor 110 may identify a distance between the first straight line and a second center point of a second virtual box among the virtual boxes at the second time point. The processor 110 may not merge associated virtual boxes based on the fact that the distance between the first straight line and the second center point of the second virtual box among the virtual boxes at the second time point is greater than or equal to a second reference length (e.g., about 20 m). For example, the processor 110 may exclude virtual boxes, each of which has the distance between the first straight line and the second center point of the second virtual box among the virtual boxes at the second time point is greater than or equal to the second reference length (e.g., about 20 m), from a merge candidate based on the fact that the distance between the first straight line and the second center point of the second virtual box among the virtual boxes at the second time point is greater than or equal to the second reference length (e.g., about 20 m). Hereinafter, an operation of not merging associated virtual boxes may include an operation of excluding the associated virtual boxes from the merge candidate.

The processor 110 may identify that the specified object is in a moving state. For example, the processor 110 may perform the following operations when the specified object is in the moving state.

The processor 110 may identify at least one of the width of each of the virtual boxes at the second time point, the length of each of the virtual boxes at the second time point, or any combination thereof. For example, the processor 110 may identify a first center point of the first virtual box among the virtual boxes at the second time point, and the second center point of the second virtual box among the virtual boxes at the second time point, based on the specified object being in the moving state and the width and length of each of the virtual boxes at the second time point being smaller than or equal to a third reference length (e.g., approximately 1 m).

The processor 110 may identify a distance between the first center point of the first virtual box among the virtual boxes at the second time point and the second center point of the second virtual box among the virtual boxes at the second time point. The processor 110 may not merge the associated virtual boxes based on the fact that the distance between the first center point of the first virtual box among the virtual boxes at the second time point and the second center point of the second virtual box among the virtual boxes at the second time point is greater than or equal to a fourth reference length (e.g., about 1.5 m).

Hereinafter, an example of merging or not merging virtual boxes at the second time point regardless of whether a specified object is in a moving state will be described.

The processor 110 may identify a virtual box, which is closest to the host vehicle including the vehicle control apparatus 100 and has a width and length greater than or equal to the fourth reference length (e.g., about 1 m), from among the virtual boxes at the second time point. The processor 110 may identify the virtual box having an assigned first identifier indicating that the virtual box is closest to the host vehicle including the vehicle control apparatus 100 and has a width and length greater than or equal to the fourth reference length (e.g., about 1 m), from among the virtual boxes at the second time point. For example, the first identifier may be referred to as a primary index.

The processor 110 may identify a virtual box, which has an assigned second identifier indicating an object separated from a road boundary, from among the virtual boxes at the second time point. For example, the second identifier may be referred to as “ContourSplitFlag”.

The processor 110 may not merge a virtual box, to which the first identifier is assigned, and a virtual box, to which the second identifier is assigned. For example, when the virtual box, to which the first identifier is assigned, and the virtual box, to which the second identifier is assigned, are attempted to be merged, the processor 110 may not merge the virtual box, to which the first identifier is assigned, and the virtual box, to which the second identifier is assigned. For example, the processor 110 may exclude the virtual box, to which the second identifier is assigned, from the merge candidate.

Hereinafter, an example of unmerging a merge box generated by merging virtual boxes at the second time point will be described.

The processor 110 may merge all or part of the associated virtual boxes based on at least one of a distance between the virtual boxes at the second time point, whether at least one of the virtual boxes at the second time point corresponds to an object separated from a road boundary, or any combination thereof. The processor 110 may generate the merge box by the merging. The processor 110 may maintain or cancel the merge based on at least one of a distance between a plurality of points included in the merge box generated by the merging, the type of the specified object, or any combination thereof.

The processor 110 may identify whether the specified objects are occluded. The processor 110 may identify types of the specified objects. The processor 110 may identify at least one of the width of the merge box, the length of the merge box, or any combination thereof.

The processor 110 may identify that the specified object is not occluded, the type of the specified object is identified as being of a different type from a second specified type indicating a specialty vehicle, and either the width or length of the merge box is greater than or equal to a fifth reference length (e.g., approximately 30 m).

For example, the specialty vehicle may include at least one of a 1-ton truck, a container truck, a heavy truck, or any combination thereof. For example, the specialty vehicle may include a vehicle that has a size larger than a passenger vehicle.

The processor 110 may identify the distance between virtual boxes at the second time point included in the merge box, based on the fact that the specified object is not occluded, the type of the specified object is identified as being of the different type from the second specified type indicating the specialty vehicle, and either the width or length of the merge box is greater than or equal to the fifth reference length.

For example, the processor 110 may identify two virtual boxes, each of which has the furthest distance, from among the virtual boxes at the second time point included in the merge box. The processor 110 may identify a distance between virtual boxes at the second time point included in the merge box based on points included in the two virtual boxes, each of which has the furthest distance, from among the virtual boxes at the second time point included in the merge box. For example, the two virtual boxes having the furthest distance among the virtual boxes at the second time point included in the merge box may be referred to as a “third virtual box” and a “fourth virtual box”, respectively.

For example, the processor 110 may identify points included in the third virtual box. For example, the processor 110 may identify points included in the fourth virtual box. The processor 110 may identify the two closest points among the points included in the third virtual box and the points included in the fourth virtual box. For example, the two closest points among the points included in the third virtual box and the points included in the fourth virtual box may be referred to as a “first point” and a “second point”, respectively.

The processor 110 may identify a distance between the first point and the second point. The processor 110 may identify that the distance between the first point and the second point exceeds a sixth reference length (e.g., about 20 m). The processor 110 may cancel the merge based on the distance between the first point and the second point exceeding the sixth reference length. For example, the sixth reference length may be smaller than the fifth reference length.

The processor 110 may cancel the merge based on at least one of whether the specified object is in a stationary state or a moving state, the type of the specified object, or any combination thereof.

For example, the processor 110 may identify that the specified object is the moving state among the stationary state and the moving state. The processor 110 may identify the type of an object corresponding to the merge box based on the fact that the specified object is identified as being in the moving state among the stationary state and moving state, the width of the merge box is smaller than or equal to a seventh reference length (e.g., approximately 4.5 m), the length of the merge box is an eighth reference length (e.g., about 20 m) that exceeds the seventh reference length, and the merge box is identified in an area beyond a specified distance from the boundary of a field of view (FOV) of the LiDAR 120. An area within the specified distance from the boundary of the FOV of the LiDAR 120 may be referred to as a “FOV boundary area”.

The processor 110 may identify the width and length of the merge box based on identifying that the type of the specified object is a first specified type including a pedestrian.

The processor 110 may unmerge the merge box based on identifying that at least one of the width of the merge box, the length of the merge box, or any combination thereof is greater than or equal to a ninth reference length (e.g., approximately 1.5 m) smaller than the seventh reference length. In detail, the processor 110 may unmerge the merge box based on identifying that one of the width of the merge box or the length of the merge box is greater than or equal to the ninth reference length smaller than the seventh reference length.

The processor 110 may obtain the merge box based on all or part of associated virtual boxes. The processor 110 may map the merge box, or virtual boxes at the second time point, to an external object. The processor 110 may identify at least one of a heading direction of the external object, a speed of the external object, the type of the external object, or any combination thereof based on the mapping of the merge box or the virtual boxes at the second time point to the external object.

As described above, the processor 110 of the vehicle control apparatus 100 may accurately map a virtual box to the external object by merging the virtual boxes at the second time point or unmerging the merge box. The processor 110 may assist in an operation of a host vehicle including the vehicle control apparatus 100 by accurately mapping the virtual box to the external object.

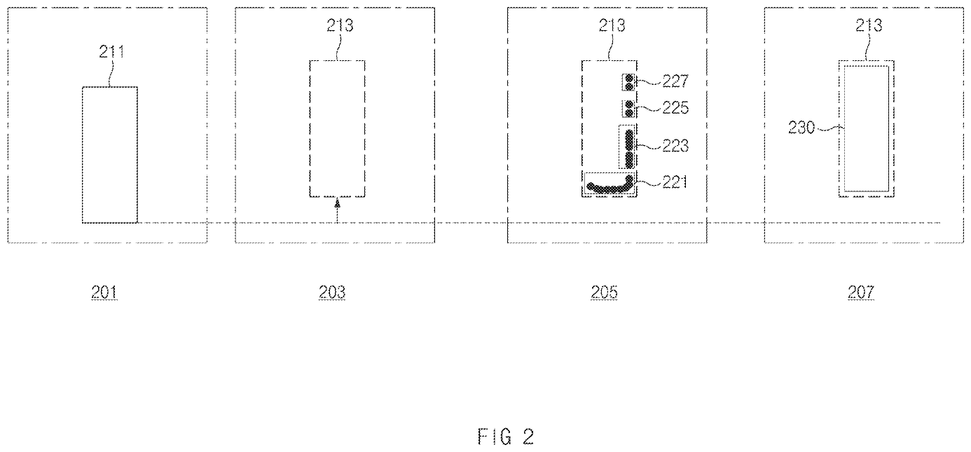

FIG. 2 shows an example of generating a merge box by using virtual boxes.

Operations of FIG. 2 may be performed by the vehicle control apparatus 100 of FIG. 1. For example, the operations of FIG. 2 may be performed by the processor 110 included in the vehicle control apparatus 100 of FIG. 1.

Referring to a first example 201 in FIG. 2, a processor included in a vehicle control apparatus may obtain a virtual box 211 of a first time point corresponding to a specified object at the first time point through a LiDAR. For example, the processor may obtain the virtual box 211 by using a plurality of points obtained at time point ‘t−1’.

Referring to a second example 203 in FIG. 2, the processor may generate a tracking box 213 obtained by converting the virtual box 211 at a first time point to a virtual box at a second time point after the first time point. For example, the second time point may be referred to as a current frame.

Referring to a third example 205 in FIG. 2, the processor may obtain virtual boxes 221, 223, 225, and 227 at the second time point formed by a plurality of points obtained at the second time point through the LiDAR.

The processor may identify the tracking box 213 and associated virtual boxes among the virtual boxes 221, 223, 225, and 227 at the second time point based on obtaining the virtual boxes 221, 223, 225, and 227 at the second time point formed by the plurality of points obtained at the second time point.

For example, the processor may determine whether the tracking box 213 is associated with the virtual boxes 221, 223, 225, and 227 at the second time point, based on at least one of a tracking point, an output point, a center point, a ratio (e.g., proportion) at which the tracking box 213 overlaps the virtual boxes 221, 223, 225, and 227 at the second time point, or any combination thereof.

For example, the processor may determine whether the tracking box 213 is associated with the virtual boxes 221, 223, 225, and 227 at the second time point, based on a correlation distance between the tracking box 213 and the virtual boxes 221, 223, 225, and 227 at the second time point.

For example, the processor may determine whether the tracking box 213 is associated with the virtual boxes 221, 223, 225, and 227 at the second time point, based on the correlation distance obtained based on Mahalanobis distance. For example, when the Mahalanobis distance is smaller than or equal to a reference distance (e.g., about 0.5 m), the processor may determine that the tracking box 213 is associated with the virtual boxes 221, 223, 225, and 227 at the second time point.

For example, the processor may determine that the tracking box 213 is associated with the virtual boxes 221, 223, 225, and 227 at the second time point, based on the fact that the tracking box 213 overlaps the virtual boxes 221, 223, 225, and 227 at the second time point by a reference ratio (e.g., approximately 25%) or more.

Referring to a fourth example 207 in FIG. 2, the processor may generate a merge box 230 based on the associated virtual boxes 221, 223, 225, and 227.

For example, the processor may merge the tracking box 213 and the associated virtual boxes 221, 223, 225, and 227. For example, the processor may merge all or part of the tracking box 213 and the associated virtual boxes 221, 223, 225, and 227.

The processor may generate the merge box 230 based on merging all or part of the associated virtual boxes 221, 223, 225, and 227.

Hereinafter, the vehicle control apparatus for generating the merge box 230 will be described later.

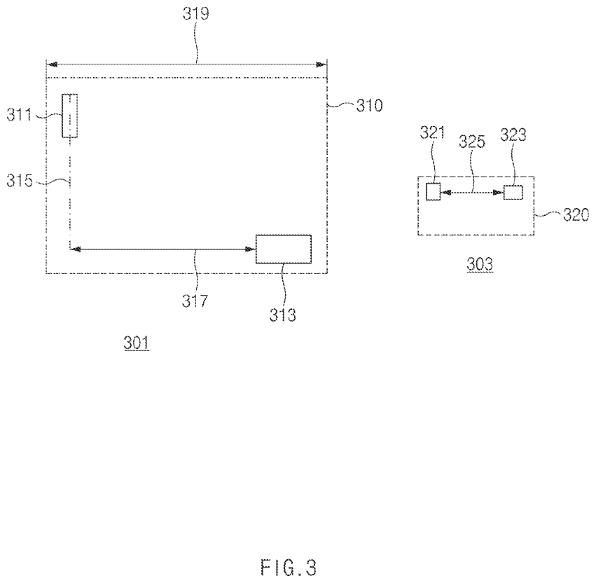

FIG. 3 shows an example of identifying a distance between virtual boxes.

Operations of FIG. 3 may be performed by the vehicle control apparatus 100 of FIG. 1. For example, the operations of FIG. 3 may be performed by the processor 110 included in the vehicle control apparatus 100 of FIG. 1.

Each of a first example 301 and a second example 303 in FIG. 3 show an example of merging all or part of virtual boxes associated with a tracking box based on a distance between the virtual boxes at a second time point.

Referring to the first example 301, a processor included in a vehicle control apparatus may identify virtual boxes 311 and 313 associated with a tracking box 310 among virtual boxes at the second time point. For example, when a specified object corresponding to the tracking box 310 is identified as being in a stationary y state, the processor may perform operations described in the first example 301.

The processor 110 may determine whether the specified object is in a stationary state or a moving state, based on at least one of whether the specified object corresponding to the tracking box 310 is occluded, the type of the specified object, the number of virtual boxes at the second time point, or any combination thereof.

The processor may identify the stationary or moving state of the specified object based on the fact that the specified object is not occluded, the type of the specified object is identified as being of a first specified type including a pedestrian, and the number of virtual boxes at the second time point is smaller than the specified number (e.g., about 3).

The processor may identify that the specified object is in a stationary state, and may identify that at least one of a width 319 of the tracking box 310, a length of the tracking box 310, or any combination thereof is greater than or equal to a first reference length (e.g., about 30 m).

For example, when the specified object corresponding to the tracking box 310 is in a stationary state, and the width 319 of the tracking box 310 is greater than or equal to 30 m, and when a distance between associated virtual boxes is greater than or equal to 20 m, the processor may not merge the associated virtual boxes.

For example, the processor may identify a first straight line 315 perpendicular to a line segment forming the first virtual box 311 from the center point of the first virtual box 311, based on the fact that the first virtual box 311 is associated with the second virtual box 313.

The processor may identify a distance 317 between the first straight line 315 and the center point of the second virtual box 313. The processor may not merge the first virtual box 311 and the second virtual box 313 based on identifying that the distance between the first straight line 315 and the center point of the second virtual box 313 is greater than or equal to a reference distance (e.g., about 20 m).

The operation in which the processor does not merge the first virtual box 311 and the second virtual box 313 may include an operation in which the processor excludes at least one of the first virtual box 311, the second virtual box 313, or any combination thereof from a merge candidate.

Referring to the second example 303, the processor may identify that a specified object is not occluded, the type of the specified object is identified as being of a first specified type including a pedestrian, the number of virtual boxes at the second time point is smaller than the specified number (e.g., 3), and the specified object is in a moving state.

The processor may identify virtual boxes 321 and 323 associated with a tracking box 320. For example, the processor may identify the first virtual box 321 associated with the tracking box 320, and the second virtual box 323 associated with the tracking box 320.

For example, the processor may identify the width and length of the first virtual box 321. The processor may identify the width and length of the second virtual box 323.

The processor may identify that each of the width and length of the first virtual box 321 is smaller than or equal to about 1 m. The processor may identify that each of the width and length of the second virtual box 323 is smaller than or equal to about 1 m.

The processor may identify the distance between the first virtual box 321 and the second virtual box 323 based on the fact that each of the width and length of the first virtual box 321 and the second virtual box 323 is smaller than or equal to about 1 m.

For example, the processor may identify the first center point of the first virtual box 321 and the second center point of the second virtual box 323. For example, at least one of the first center point of the first virtual box 321, the second center point of the second virtual box 323, or any combination thereof may be obtained based on a coordinate system that is centered on a host vehicle and uses a location of the host vehicle including a vehicle control apparatus as an origin point.

The processor may identify a distance 325 between the first center point of the first virtual box 321 and the second center point of the second virtual box 323 based on identifying the first center point of the first virtual box 321 and the second center point of the second virtual box 323.

The processor may not merge the first virtual box 321 and the second virtual box 323 based on identifying that the distance 325 between the first center point of the first virtual box 321 and the second center point of the second virtual box 323 is greater than or equal to about 1.5 m.

The operation in which the processor does not merge the first virtual box 321 and the second virtual box 323 may include an operation in which the processor excludes at least one of the first virtual box 321, the second virtual box 323, or any combination thereof from a merge candidate.

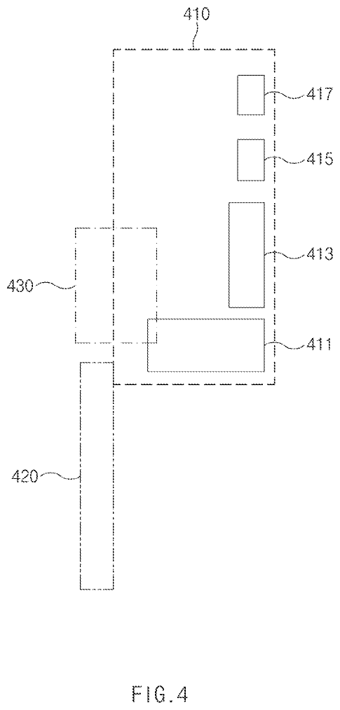

FIG. 4 shows an example in which an object separated from a road boundary and virtual boxes at a second time point are not merged.

Operations of FIG. 4 may be performed by the vehicle control apparatus 100 of FIG. 1. For example, the operations of FIG. 4 may be performed by the processor 110 included in the vehicle control apparatus 100 of FIG. 1.

Referring to FIG. 4, a processor included in a vehicle control apparatus may generate a tracking box 410 obtained by converting a virtual box at a first time point to a virtual box at a second time point after the first time point.

The processor may obtain virtual boxes 411, 413, 415, 417, 420, and 430 at the second time point, which are formed by a plurality of points obtained at the second time point, through a LiDAR.

The processor may identify the virtual boxes 411, 413, 415, 417, and 430 associated with the tracking box 410 among the virtual boxes 411, 413, 415, 417, 420, and 430 at the second time point.

The processor may identify virtual boxes associated with the tracking box 410 based on at least one of a ratio (e.g., proportion) at which the tracking box 410 overlaps the virtual boxes, a correlation distance between points included in the tracking box and points included in the virtual boxes, or any combination thereof.

The processor may identify the virtual box 411, which has a first identifier indicating that the virtual box 411 is closest to a host vehicle including the vehicle control apparatus and has the width and length, each of which is greater than or equal to the fourth reference length (e.g., about 1 m), from among the virtual boxes 411, 413, 415, 417, and 430 associated with the tracking box 410. For example, the first identifier may be referred to as a primary index.

At least one of a location reference point of a merge box, a feature of the merge box, or any combination thereof may be determined by using the virtual box 411 to which the first identifier is assigned. For example, the processor may determine at least one of the location reference point of the merge box, the feature of the merge box, or any combination thereof based on a location reference point of the virtual box 411, to which the first identifier is assigned, and a feature of the virtual box 411.

The processor may identify the virtual box 430, which has a second identifier indicating an object separated from a road boundary, from among the virtual boxes at the second time point. For example, the second identifier may be referred to as “ContourSplitFlag”.

For example, in FIG. 4, the virtual box 420 may include a virtual box corresponding to a road boundary. In FIG. 4, the virtual box 430 may include a virtual box corresponding to an object separated from the virtual box 430 corresponding to a road boundary.

When attempting to merge the virtual box 430, to which the second identifier is assigned, and the virtual box 411 to which the first identifier is assigned, the processor may exclude the virtual box 430, to which the second identifier is assigned, from a merge candidate. For example, the processor may not merge the virtual box 430, to which the second identifier is assigned, and the virtual box 411 to which the first identifier is assigned.

The processor may not merge the virtual box 430, to which the second identifier is assigned, with the virtual box 411, to which the first identifier is assigned, and thus may obtain a merge box based on the virtual boxes 411, 413, 415, and 417 associated with the tracking box. For example, the processor may perform merging while excluding the virtual box 430, to which the second identifier is assigned, from among the virtual boxes 411, 413, 415, 417, and 430 associated with the tracking box 410.

As described above, the processor of the vehicle control apparatus may perform merging, while excluding the virtual box 430, to which the second identifier is assigned, from among the virtual boxes 411, 413, 415, 417, and 430 associated with the tracking box 410, thereby preventing the shape of the virtual box 420 corresponding to a road boundary from being expanded abnormally.

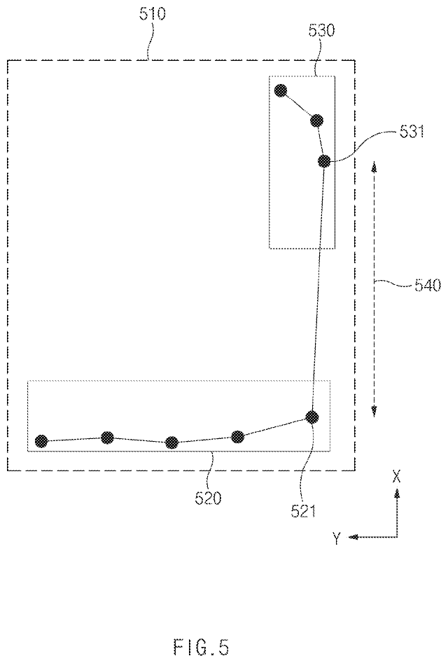

FIG. 5 shows an example of separating a merge box based on a plurality of points included in virtual boxes.

Operations of FIG. 5 may be performed by the vehicle control apparatus 100 of FIG. 1. For example, the operations of FIG. 5 may be performed by the processor 110 included in the vehicle control apparatus 100 of FIG. 1.

Referring to FIG. 5, a processor included in a vehicle control apparatus may merge all or part of virtual boxes associated with a tracking box. The processor may generate a merge box 510 based on merging all or part of virtual boxes 520 and 530 associated with the tracking box.

The processor may identify the virtual boxes 520 and 530, which are furthest spaced from each other, from among virtual boxes at a second time point included in the merge box 510.

The processor may identify the first virtual box 520, which is located relatively close to a host vehicle, based on identifying virtual boxes, which are furthest spaced from each other, from among the virtual boxes at the second time point. The processor may identify the second virtual box 530, which is different from the first virtual box 520 located relatively close to the host vehicle, based on identifying virtual boxes, which are furthest spaced from each other, from among the virtual boxes at the second time point.

The processor may identify points included in the first virtual box 520. The processor may identify a first point 521, which is closest to the second virtual box 530, from among the points included in the first virtual box 520.

The processor may identify points included in the second virtual box 530. The processor may identify a second point 531, which is closest to the second virtual box 520, from among the points included in the second virtual box 530.

The processor may identify a distance between the first point 521 and the second point 531. The processor may identify a distance 540 in an x-axis direction between the first point 521 and the second point 531.

For example, the processor may identify coordinates of the first point 521. For example, the processor may identify coordinates of the second point 531.

The processor may identify the distance 540 in the x-axis direction between the first point 521 and the second point 531 by using the x-coordinate of the coordinates of the first point 521 and the x-coordinate of the coordinates of the second point 531.

The processor may identify that the distance between the first point 521 and the second point 531 exceeds the sixth reference length (e.g., about 20 m) smaller than the fifth reference length. The processor may cancel the merge based on the distance between the first point 521 and the second point 531 exceeding the sixth reference length.

For example, the processor may unmerge the merge box 510 based on the distance between the first point 521 and the second point 531 exceeding the sixth reference length.

The processor may cancel the merging based on the fact that the distance 540 in the x-axis direction between the first point 521 and the second point 531 exceeds the sixth reference length.

The processor may map the virtual boxes 520 and 530 to external objects based on the unmerging.

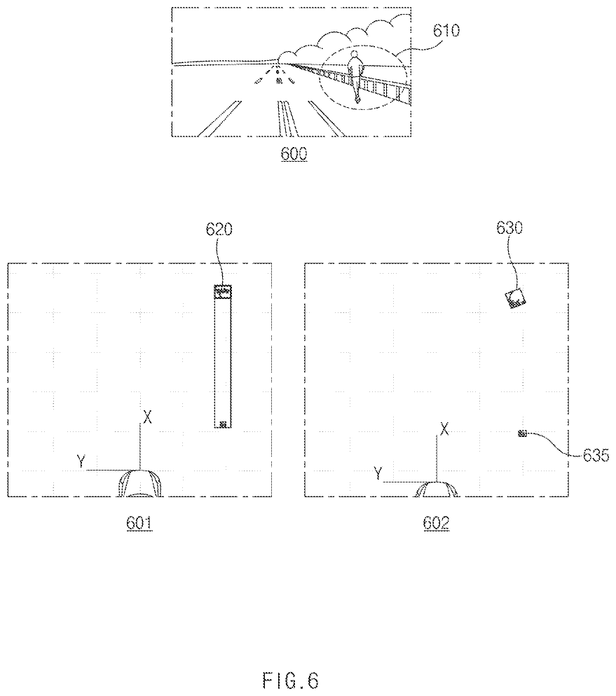

FIG. 6 shows an example of a result of separating a merge box.

Operations of FIG. 6 may be performed by the vehicle control apparatus 100 of FIG. 1. For example, the operations of FIG. 6 may be performed by the processor 110 included in the vehicle control apparatus 100 of FIG. 1.

A first example 600 in FIG. 6 may include an example of an image representing surrounding environments of a host vehicle.

A second example 601 in FIG. 6 may include an example of outputting a merge box without applying the present technology.

A third example 602 in FIG. 6 may include an example of unmerging and outputting a merge box by applying the present technology.

Referring to the second example 601, a processor may generate a merge box 620 and may output the generated merge box 620. Even when virtual boxes included in the merge box 620 are located to be far away from each other, the processor may output the merge box 620 without unmerging the merge box 620.

A pedestrian 610 and a guardrail may be output as one object by outputting the merge box 620 without unmerging the merge box 620.

Referring to the third example 602, the processor may unmerge the merge box 620. The processor may output a first virtual box 630 and a second virtual box 635 based on unmerging the merge box 620.

Alternatively, the processor may output virtual boxes at a second time point with the virtual boxes unmerged.

For example, the first virtual box 630 may support a part of the guardrail. For example, the second virtual box 635 may correspond to the pedestrian 610.

The processor included in the vehicle control apparatus may accurately map the virtual boxes 630 and 635 to external objects by not merging the first virtual box 630 and the second virtual box 635, or unmerging the merge box.

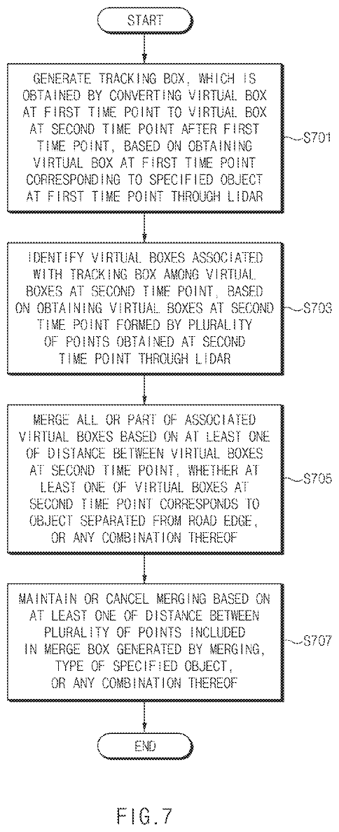

FIG. 7 shows an example of a flowchart of a vehicle control method.

Hereinafter, a vehicle controlling method will be described in detail with reference to FIG. 7. FIG. 7 is a flowchart for describing a vehicle controlling method.

Hereinafter, it is assumed that the vehicle controlling apparatus 100 of FIG. 1 performs the process of FIG. 7. In addition, in a description of FIG. 7, it may be understood that an operation described as being performed by an apparatus is controlled by the processor 110 of the vehicle control apparatus 100.

At least one of operations of FIG. 7 may be performed by the vehicle control apparatus 100 of FIG. 1. Each of the operations in FIG. 7 may be performed sequentially, but is not necessarily sequentially performed. For example, the order of operations may be changed, and at least two operations may be performed in parallel.

Referring to FIG. 7, in operation S701, a vehicle control method may include an operation of generating a tracking box, which is obtained by converting a virtual box at a first time point to a virtual box at a second time point after the first time point, based on obtaining virtual boxes at the first time point corresponding to a specified object at the first time point through a LiDAR.

For example, the vehicle control method may include an operation of generating the tracking box based on merging virtual boxes at the first time point.

In operation S703, the vehicle control method may include an operation of identifying the virtual boxes associated with the tracking box among virtual boxes at the second time point, based on obtaining the virtual boxes at the second time point formed by a plurality of points obtained at the second time point through the LiDAR.

For example, the vehicle control method may include an operation of determining whether the virtual boxes at the second time point are associated with the tracking box, based on at least one of a ratio (e.g., proportion) at which the virtual boxes at the second time point overlap the tracking box, a correlation distance between the virtual boxes at the second time point and the tracking box, or any combination thereof.

In operation S705, the vehicle control method may include an operation of merging all or part of the associated virtual boxes based on at least one of a distance between the virtual boxes at the second time point, whether at least one of the virtual boxes at the second time point corresponds to an object separated from a road boundary, or any combination thereof.

For example, the vehicle control method may include an operation of generating a merge box based on merging all or part of the associated virtual boxes.

In operation S707, the vehicle control method may include an operation of maintaining or canceling the merging based on at least one of a distance between a plurality of points included in the merge box generated by the merging, the type of the specified object, or any combination thereof.

The vehicle control method may include an operation of mapping a merge box to an external object or outputting a merge box, when maintaining the merging.

The vehicle control method may include an operation of mapping virtual boxes, for which the merging is canceled and which is obtained at the second time point, to external objects, or separating and outputting the merge box into virtual boxes at the second time point, when canceling the merging.

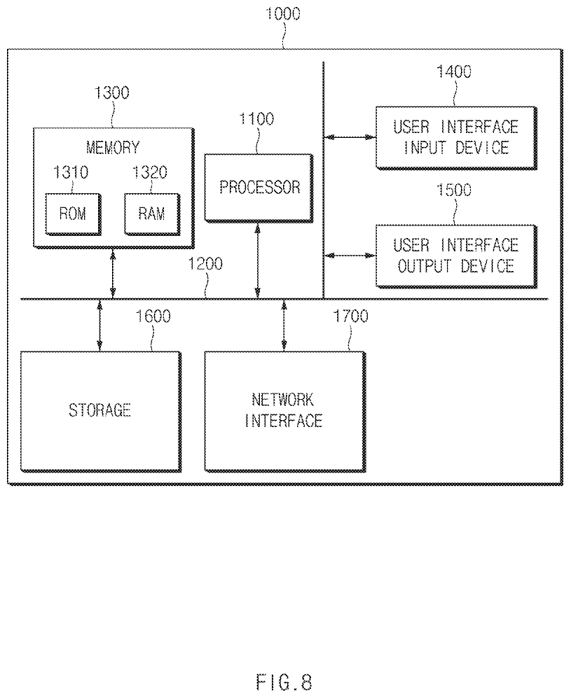

FIG. 8 shows a computing system associated with a vehicle control apparatus.

Referring to FIG. 8, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the one or more example embodiments disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The above description is merely an example of the technical idea of the present disclosure, and various modifications and modifications may be made by one skilled in the art without departing from the essential characteristic of the present disclosure.

Accordingly, the present disclosure is intended not to limit but to explain the technical idea of the present disclosure, and the scope and spirit of the present disclosure is not limited by the one or more example embodiments described herein. The scope of protection of the present disclosure should be construed by the attached claims, and all equivalents thereof should be construed as being included within the scope of the present disclosure.

A vehicle control apparatus may merge virtual boxes generated by using a LiDAR or may unmerges the merge box.

Moreover, the vehicle control apparatus may reduce a load of a processor by determining whether to merge virtual boxes before merging the virtual boxes.

Furthermore, the vehicle control apparatus may accurately identify a pedestrian when it is identified that the pedestrian is separated from a road boundary, such as a guardrail, a median, or a curb.

Besides, a variety of effects directly or indirectly understood through the specification may be provided.

Hereinabove, although the present disclosure has been described with reference to one or more example embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle control apparatus comprising:
a sensor; and
a processor configured to:
convert a first virtual box, associated with a first object and obtained via the sensor at a first time, into a second virtual box associated with a second time that is later than the first time;
determine a plurality of third virtual boxes, associated with the second virtual box, based on a plurality of data points obtained at the second time via the sensor;
merge at least part of the plurality of third virtual boxes into a merge box based on at least one of:
a distance between two or more of the plurality of third virtual boxes at the second time, or
whether at least one of the plurality of third virtual boxes at the second time corresponds to a second object that is separated from a road boundary;
maintain or cancel the merging of the at least part of the plurality of third virtual boxes based on at least one of:
a distance between two or more data points included in the merge box, or
a type of the first object; and
output a signal indicating a result of the maintaining or canceling of the merging.

2. The vehicle control apparatus of claim 1, wherein the processor is configured to determine the plurality of third virtual boxes by determining the plurality of third virtual boxes based on at least one of:
the second virtual box overlapping each of the plurality of third virtual boxes at the second time by a proportion greater than a first threshold value, or
a distance between a plurality of first data points included in the second virtual box and a plurality of second data points included in the plurality of third virtual boxes at the second time being within a second threshold value.

3. The vehicle control apparatus of claim 1, wherein the processor is further configured to:
determine whether the first object is stationary or moving based on at least one of:
the first object being not occluded,
the type of the first object being a pedestrian, or
a number of the plurality of third virtual boxes at the second time being less than a threshold value.

4. The vehicle control apparatus of claim 1, wherein the at least part of the plurality of third virtual boxes comprises a fourth virtual box and a fifth virtual box, and wherein the processor is configured to maintain or cancel the merging by canceling the merging based on:
the first object being stationary,
at least one of a width or a length of the second virtual box being greater than or equal to a first threshold value, and
a distance between a first straight line, which is perpendicular to a line segment forming the fourth virtual box and passes a center of the fourth virtual box at the second time, and a center of the fifth virtual box at the second time being greater than or equal to a second threshold value.

5. The vehicle control apparatus of claim 1, wherein the at least part of the plurality of third virtual boxes comprises a fourth virtual box and a fifth virtual box, and wherein the processor is configured to maintain or cancel the merging by canceling the merging based on:
the first object being moving,
a width and a length of each of the plurality of third virtual boxes at the second time being less than or equal to a first threshold value, and
a distance between a center of the fourth virtual box and a center of the fifth virtual box being greater than or equal to a second threshold value that is greater than the first threshold value.

6. The vehicle control apparatus of claim 1, wherein the processor is further configured to:
determine, among the plurality of third virtual boxes at the second time, a fourth virtual box that is closest to a vehicle associated with the vehicle control apparatus, wherein a width and a length of the fourth virtual box are greater than or equal to a threshold value;
determine, among the plurality of third virtual boxes at the second time, a fifth virtual box associated with the second object; and
cancel merging of the fourth virtual box and the fifth virtual box.

7. The vehicle control apparatus of claim 1, wherein the processor is further configured to:
determine a fourth virtual box and a fifth virtual box that are, among the plurality of third virtual boxes at the second time, furthest away from each other based on:
the first object being not occluded,
the type of the first object not being a specialty vehicle, and
one of a width or a length of the merge box being greater than or equal to a first threshold value.

8. The vehicle control apparatus of claim 7, wherein the processor is further configured to:
cancel merging of the fourth virtual box and the fifth virtual box based on a distance between a first data point, in the fourth virtual box, closest to the fifth virtual box and a second data point, in the fifth virtual box, closest to the fourth virtual box being greater than a second threshold value that is less than the first threshold value.

9. The vehicle control apparatus of claim 1, wherein the processor is further configured to determine an object type associated with the merge box based on:
the first object being moving,
a width of the merge box being less than or equal to a first threshold value,
a length of the merge box being less than or equal to a second threshold value that is greater than the first threshold value, and
the merge box being associated with an area that is at least a threshold distance away from a boundary of a field of view of the sensor.

10. The vehicle control apparatus of claim 9, wherein the processor is configured to maintain or cancel the merging by canceling the merging based on:
the type of the first object being a pedestrian, and
one of the width of the merge box or the length of the merge box being greater than or equal to a third threshold value threshold value that is less than the first threshold value.

11. A vehicle control method comprising:
converting, by one or more processors of a vehicle, a first virtual box, associated with a first object and obtained via a sensor at a first time, into a second virtual box associated with a second time that is later than the first time;
determining a plurality of third virtual boxes, associated with the second virtual box, based on a plurality of data points obtained at the second time via the sensor;
merging at least part of the plurality of third virtual boxes into a merge box based on at least one of:
a distance between two or more of the plurality of third virtual boxes at the second time, or
whether at least one of the plurality of third virtual boxes at the second time corresponds to a second object that is separated from a road boundary; and
maintaining or canceling the merging of the at least part of the plurality of third virtual boxes based on at least one of:
a distance between two or more data points included in the merge box, or
a type of the first object; and
outputting a signal indicating a result of the maintaining or canceling of the merging.

12. The method of claim 11, wherein the determining of the plurality of third virtual boxes comprises determining the plurality of third virtual boxes based on at least one of:
the second virtual box overlapping each of the plurality of third virtual boxes at the second time by a proportion greater than a first threshold value, or
a distance between a plurality of first data points included in the second virtual box and a plurality of second data points included in the plurality of third virtual boxes at the second time being within a second threshold value.

13. The method of claim 11, further comprising:
determining whether the first object is stationary or moving based on at least one of:
the first object being not occluded,
the type of the first object being a pedestrian, or
a number of the plurality of third virtual boxes at the second time being less than a threshold value.

14. The method of claim 11, wherein the at least part of the plurality of third virtual boxes comprises a fourth virtual box and a fifth virtual box, and wherein the maintaining or canceling of the merging comprises cancelling the merging based on:
the first object being stationary,
at least one of a width or a length of the second virtual box being greater than or equal to a first threshold value, and
a distance between a first straight line, which is perpendicular to a line segment forming the fourth virtual box and passes a center of the fourth virtual box at the second time, and a center of the fifth virtual box at the second time being greater than or equal to a second threshold value.

15. The method of claim 11, wherein the at least part of the plurality of third virtual boxes comprises a fourth virtual box and a fifth virtual box, and wherein the maintaining or canceling of the merging comprises canceling the merging based on:
the first object being moving,
a width and a length of the plurality of third virtual boxes at the second time being less than or equal to a first threshold value, and
a distance between a center of the fourth virtual box and a center of the fifth virtual box being greater than or equal to a second threshold value greater than the first threshold value.

16. The method of claim 11, further comprising:
determining, among a plurality of third virtual boxes at the second time, a fourth virtual box that is closest to the vehicle, wherein a width and a length of the fourth virtual box are greater than or equal to a threshold value;
determining, among the plurality of third virtual boxes at the second time, a fifth virtual box associated with the second object; and
canceling merging of the fourth virtual box and the fifth virtual box.

17. The method of claim 11, further comprising:
determining a fourth virtual box and a fifth virtual box that are, among the plurality of third virtual boxes at the second time, furthest away from each other based on:
the first object being not occluded,
the type of the first object not being a specialty vehicle, and
one of a width or a length of the merge box being greater than or equal to a first threshold value.

18. The method of claim 17, further comprising:
canceling merging of the fourth virtual box and the fifth virtual box based on a distance between a first data point, in the fourth virtual box, closest to the fifth virtual box and a second data point, in the fifth virtual box, closest to the fourth virtual box being greater than a second threshold value that is less than the first threshold value.

19. The method of claim 11, further comprising determining an object type associated with the merge box based on:
the first object being moving,
a width of the merge box being less than or equal to a first threshold value,
a length of the merge box being less than or equal to a second threshold value that is greater than the first threshold value, and
the merge box being associated with an area that is at least a threshold distance away from a boundary of a field of view of the sensor.

20. The method of claim 19, wherein the maintaining or canceling of the merging comprises canceling the merging based on:
the type of the first object being a pedestrian, and
one of the width of the merge box or the length of the merge box being greater than or equal to a third threshold value threshold value that is less than the first threshold value.
